(19) United States
(12) Patent Application Publication
(10) Pub. No.: US 2026/0286157 A1
(43) Pub. Date: Sep. 24, 2026

(54) IMAGE FORMING APPARATUS AND INK COMPOSITION

(71) Applicants: Shunsuke HORIE, Kanagawa (JP); Hiroshi GOTOU, Shizuoka (JP); Yuta NAKAMURA, Tokyo (JP); Ayaka MATSUMOTO, Kanagawa (JP)

(72) Inventors: Shunsuke HORIE, Kanagawa (JP); Hiroshi GOTOU, Shizuoka (JP); Yuta NAKAMURA, Tokyo (JP); Ayaka MATSUMOTO, Kanagawa (JP)

(21) Appl. No.: 19/558,796

(22) Filed: Mar. 6, 2026

(30) Foreign Application Priority Data
Mar. 18, 2025 (JP) 2025-043216

(51) Int. Cl. C09D 11/38; B41J 29/00

(52) U.S. Cl. CPC C09D 11/38; B41J 29/00

(57) ABSTRACT

An image forming apparatus includes an ink composition and a discharge head. The ink composition has a total solid content of 5% by mass or more and 15% by mass or less, and includes: an organic solvent in an amount of 14% by mass or more and 20% by mass or less of the ink composition, the organic solvent including a high-boiling point organic solvent having a boiling point of 200° C. or more and 300° C. or less in an amount of 10% by mass or more and 20% by mass or less of the ink composition; water; a colorant; a resin; and a surfactant including a compound having a specific formula. The discharge head discharges the ink composition onto a recording substrate with a deposition amount of 0.6 μL/cm² or less when printing an image on the recording substrate at a droplet count of 1200×1200 dpi.

### CROSS-REFERENCE TO RELATED APPLICATION

This patent application is based on and claims priority pursuant to 35 U.S.C. § 119 (a) to Japanese Patent Application No. 2025-043216, filed on Mar. 18, 2025, in the Japan Patent Office, the entire disclosure of which is hereby incorporated by reference herein.

### BACKGROUND

### Technical Field

The present disclosure relates to an image forming apparatus and an ink composition.

### Related Art

An image forming apparatus such as an inkjet printer has advantages such as low noise, low running cost, and ease of color printing, and is widely used as a device for outputting a digital signal.

Examples of widely employed inks used in an inkjet printer include, but are not limited to, solvent-based inks using an organic solvent as a solvent, and UV-curable inks including mainly polymerizable monomers. However, the solvent-based inks raise concerns about environmental impacts due to evaporation of organic solvents. From the standpoint of safety, the UV-curable inks have limited options for the polymerizable monomers that can be used.

Therefore, there are proposed ink sets including an aqueous ink with a low environmental impact. However, when the aqueous ink is printed on a recording sheet from a discharge apparatus, the ink landing on the sheet may permeate into the interior of the sheet, and thus may lead to a reduction in image density and chroma.

To increase the image density, a method is conceivable in which the droplet volume when the ink is discharged is increased to increase the amount of the ink deposited on the recording sheet. However, when the droplet volume is increased, a thermal energy taken to dry and fix an ink film also increases, leading to a decrease in productivity. A time taken for drying also increases, and thus, a state such as bleeding and beading in which the image quality degrades may occur.

On the other hand, if the droplet volume during ink discharge is reduced to improve drying efficiency and suppress blur and beading, dots formed by the ink droplets landing on the recording sheet become smaller, and thus, the background color of the recording sheet may be exposed, which may cause a decrease in image density and chroma.

To satisfy all of image density, drying efficiency, and image quality impact, a technique has been proposed to increase the wettability of the ink droplets to the recording sheet. When the wettability for the recording sheet is increased, the formed dots are enlarged, and thus, it is possible to suppress the exposure of the background color by improving the sheet coverage efficiency of the ink film.

Generally, to increase the drying efficiency of the ink, it is conceivable to include a low-boiling-point solvent in the ink solvent and to add a non-volatile component to the ink. In particular, when a resin as a non-volatile component is added, it is possible to expect to improve the fastness of the formed image. However, when the low-boiling-point solvent and the non-volatile component are used, the ink droplets landing on the recording sheet solidify before such ink droplets spread while wetting the recording sheet, which increases the area where the background color of the recording sheet is exposed, and thus, the image density and chroma may possibly decrease.

### SUMMARY

Embodiments of the present invention provide an image forming apparatus that includes an ink composition and a discharge head. The ink composition has a total solid content of 5% by mass or more and 15% by mass or less, and includes: an organic solvent in an amount of 14% by mass or more and 20% by mass or less of the ink composition, the organic solvent including a high-boiling point organic solvent having a boiling point of 200° C. or more and 300° C. or less in an amount of 10% by mass or more and 20% by mass or less of the ink composition; water; a colorant; a resin; and a surfactant including a compound having a specific formula. The discharge head discharges the ink composition onto a recording substrate with a deposition amount of 0.6 μL/cm² or less when printing an image on the recording substrate at a droplet count of 1200×1200 dpi.

### BRIEF DESCRIPTION OF THE DRAWINGS

A more complete appreciation of embodiments of the present disclosure and many of the attendant advantages and features thereof can be readily obtained and understood from the following detailed description with reference to the accompanying drawings, wherein:

FIG. 1 is a diagram illustrating an image printing apparatus being an example of an image forming apparatus; and

FIG. 2 is a diagram illustrating an example of a main tank included in an image printing apparatus.

The accompanying drawings are intended to depict embodiments of the present disclosure and should not be interpreted to limit the scope thereof. The accompanying drawings are not to be considered as drawn to scale unless explicitly noted. Also, identical or similar reference numerals designate identical or similar components throughout the several views.

### DETAILED DESCRIPTION

In describing embodiments illustrated in the drawings, specific terminology is employed for the sake of clarity. However, the disclosure of this specification is not intended to be limited to the specific terminology so selected and it is to be understood that each specific element includes all technical equivalents that have a similar function, operate in a similar manner, and achieve a similar result.

Referring now to the drawings, embodiments of the present disclosure are described below. As used herein, the singular forms “a”, “an”, and “the” are intended to include the plural forms as well, unless the context clearly indicates otherwise.

According to embodiments of the present disclosure, an image forming apparatus that can improve drying efficiency, image coverage, and image quality is provided.

Embodiments of the present disclosure will be described below.

### <Image Forming Apparatus>

An image forming apparatus according to the present embodiment includes an ink composition and a discharge head.

### <Ink Composition>

The ink composition includes an organic solvent, water, a colorant, a resin, and a surfactant, and may further include additives.

### <Organic Solvent>

The organic solvent may function as a wetting agent in the ink composition. The organic solvent is not particularly limited, and examples of the organic solvent include, but are not limited to, polyhydric alcohols, polyhydric alcohol alkyl ethers, ethers such as aryl ethers, nitrogen-containing heterocyclic compounds, amides, amines, and sulfur-containing compounds. Among these, water-soluble organic solvents are preferable as the organic solvent.

Specific examples of the water-soluble organic solvents include, but are not limited to, polyhydric alcohols such as ethylene glycol, diethylene glycol, 1,2-propanediol, 1,3-propanediol, 1,2-butanediol, 1,3-butanediol, 1,4-butanediol, 2,3-butanediol, 3-methyl-1,3-butanediol, triethylene glycol, polyethylene glycol, polypropylene glycol, 1,2-pentanediol, 1,3-pentanediol, 1,4-pentanediol, 2,4-pentanediol, 1,5-pentanediol, 1,2-hexanediol, 1,6-hexanediol, 1,3-hexanediol, 2,5-hexanediol, 1,5-hexanediol, glycerin, 1,2,6-hexanetriol, 2-ethyl-1,3-hexanediol, ethyl-1,2,4-butanetriol, 1,2,3-butanetriol, 2,2,4-trimethyl-1,3-pentanediol, and petriol; polyhydric alcohol alkyl ethers such as ethylene glycol monoethyl ether, ethylene glycol monobutyl ether, diethylene glycol monomethyl ether, diethylene glycol monoethyl ether, diethylene glycol monobutyl ether, tetraethylene glycol monomethyl ether, and propylene glycol monoethyl ether; polyhydric alcohol aryl ethers such as ethylene glycol monophenyl ether and ethylene glycol monobenzyl ether; polyol compounds having eight or more carbon atoms; glycol ether compounds; nitrogen-containing heterocyclic compounds such as 2-pyrrolidone, N-methyl-2-pyrrolidone, N-hydroxyethyl-2-pyrrolidone, 1,3-dimethyl-2-imidazolidinone, ¿-caprolactam, and γ-butyrolactone; amides such as formamide, N-methylformamide, N,N-dimethylformamide, 3-methoxy-N,N-dimethylpropionamide, and 3-butoxy-N,N-dimethylpropionamide; amines such as monoethanolamine, diethanolamine, and triethylamine; sulfur-containing compounds such as dimethyl sulfoxide, sulfolane, and thiodiethanol; propylene carbonate; and ethylene carbonate.

The organic solvents not only function as a wetting agent but also include a high-boiling point organic solvent having a boiling point of 200° C. or more and 300° C. or less (hereinafter referred to as “high-boiling point organic solvent”) because good drying properties are obtained. The high-boiling point organic solvent is preferably a high-boiling point organic solvent having a boiling point of 200° C. or more and 230° C. or less, and more preferably a high-boiling point organic solvent having a boiling point of 200° C. or more and 250° C. or less. As such a high-boiling point organic solvent, a glycol ether compound and a polyol compound having eight or more carbon atoms are preferably used.

Specific examples of the polyol compounds having eight or more carbon atoms include, but are not limited to, 2-ethyl-1,3-hexanediol and 2,2,4-trimethyl-1,3-pentanediol.

Specific examples of the glycol ether compound include, but are not limited to, polyhydric alcohol alkyl ethers such as glycol ethers including ethylene glycol monomethyl ether, ethylene glycol monoethyl ether, ethylene glycol monobutyl ether, ethylene glycol monomethyl ether acetate, diethylene glycol monomethyl ether, diethylene glycol monoethyl ether, diethylene glycol mono-n-propyl ether, ethylene glycol mono-iso-propyl ether, diethylene glycol mono-iso-propyl ether, ethylene glycol mono-n-butyl ether, ethylene glycol mono-t-butyl ether, diethylene glycol mono-t-butyl ether, triethylene glycol monobutyl ether, 1-methyl-1-methoxybutanol, propylene glycol monomethyl ether, propylene glycol monoethyl ether, propylene glycol mono-t-butyl ether, propylene glycol mono-n-propyl ether, propylene glycol mono-iso-propyl ether, dipropylene glycol monomethyl ether, dipropylene glycol monoethyl ether, dipropylene glycol mono-n-propyl ether, and dipropylene glycol mono-iso-propyl ether; and polyhydric alcohol aryl ethers such as ethylene glycol monophenyl ether and ethylene glycol monobenzyl ether.

The polyol compound having eight or more carbon atoms and the glycol ether compound can improve permeability of the ink when paper is employed for a recording medium.

The content of the organic solvent in the ink composition is 14% by mass or more and 20% by mass or less, preferably 14.5% by mass or more and 19.5% by mass or less, and more preferably 15% by mass or more and 19% by mass or less. The content of the high-boiling-point organic solvent in the ink composition is 10% by mass or more and 20% by mass or less, preferably 10.5% by mass or more and 19.5% by mass or less, and more preferably 11% by mass or more and 19% by mass or less. When the contents of the organic solvent and the high-boiling point organic solvent in the ink composition are within the above ranges, both the drying properties of the ink droplets and the image quality can be achieved.

It is noted that if the contents of the organic solvent and the high-boiling-point organic solvent in the ink composition are too low, the drying property becomes too high, causing the dots to fix on the recording sheet before the dots spread. This deteriorates the image coverage efficiency and results in a decrease in image density due to the exposure of the background of the recording sheet. If the contents of the organic solvent and the high-boiling-point organic solvent in the ink composition are too high, the drying property of the ink droplet after landing deteriorates, leading to a decrease in productivity and adverse effects on image quality such as blur and bleeding.

### <Water>

Water is not particularly limited, and examples of the water include, but are not limited to, pure water, distilled water, and deionized water. The content of water in the ink composition is not particularly limited and may be appropriately selected depending on the intended use. However, from the viewpoint of ink drying properties and discharge reliability, the content is preferably 10% by mass or more and 90% by mass or less, more preferably 30% by mass or more and 85% by mass or less, and even more preferably 50% by mass or more and 80% by mass or less.

### <Colorant>

The colorant is not particularly limited, and pigments and dyes may be employed for the colorant.

Examples of the pigments to be used include, but are not limited to, black pigments, yellow pigments, magenta pigments, cyan pigments, white pigments, green pigments, orange pigments, glossy color pigments (for example, gold pigments and silver pigments), and metallic pigments. The usable pigments include either inorganic pigments or organic pigments. Such pigments may be used alone or in combination of two or more types. Mixed crystals may also be employed for the pigments.

Examples of the inorganic pigments include, but are not limited to, titanium oxide, iron oxide, calcium carbonate, barium sulfate, aluminum hydroxide, Barium Yellow, Cadmium Red, and Chrome Yellow, as well as carbon black produced by a well-known method such as a contact method, a furnace method, and a thermal method.

Examples of the organic pigments include, but are not limited to, azo pigments, polycyclic pigments (for example, phthalocyanine pigments, perylene pigments, perinone pigments, anthraquinone pigments, quinacridone pigments, dioxazine pigments, indigo pigments, thioindigo pigments, isoindolinone pigments, and quinophthalone pigments), dye chelates (for example, basic dye chelates and acid dye chelates), nitro pigments, nitroso pigments, and aniline black. Among such pigments, pigments having good affinity for solvents are preferred. In addition, hollow resin particles and inorganic hollow particles may also be used.

Specific examples of the pigments used for black pigments include, but are not limited to: carbon blacks such as furnace black, lamp black, acetylene black, and channel black (C.I. Pigment Black 7); metals such as copper, iron (C.I. Pigment Black 11), and titanium oxide; and organic pigments such as aniline black (C.I. Pigment Black 1).

Examples of the pigments used for color printing include, but are not limited to: C.I. Pigment Yellow 1, 3, 12, 13, 14, 17, 24, 34, 35, 37, 42 (Yellow Iron Oxide), 53, 55, 74, 81, 83, 95, 97, 98, 100, 101, 104, 108, 109, 110, 117, 120, 138, 150, 153, 155, 180, 185, and 213; C.I. Pigment Orange 5, 13, 16, 17, 36, 43, and 51; C.I. Pigment Red 1, 2, 3, 5, 17, 22, 23, 31, 38, 48:2, 48:2 (Permanent Red 2B(Ca)), 48:3, 48:4, 49:1, 52:2, 53:1, 57:1 (Brilliant Carmine 6B), 60:1, 63:1, 63:2, 64:1, 81, 83, 88, 101 (Red Iron Oxide), 104, 105, 106, 108 (Cadmium Red), 112, 114, 122 (Quinacridone Magenta), 123, 146, 149, 166, 168, 170, 172, 177, 178, 179, 184, 185, 190, 193, 202, 207, 208, 209, 213, 219, 224, 254, and 264; C.I. Pigment Violet 1 (Rhodamine Lake), 3, 5:1, 16, 19, 23, and 38; C.I. Pigment Blue 1, 2, 15 (Phthalocyanine Blue), 15:1, 15:2, 15:3, 15:4 (Phthalocyanine Blue), 16, 17:1, 56, 60, and 63; and C.I. Pigment Green 1, 4, 7, 8, 10, 17, 18, and 36.

Dyes are not particularly limited, and acid dyes, direct dyes, reactive dyes, and basic dyes may be used. Such dyes may be used alone or in combination of two or more types.

Examples of the dyes include, but are not limited to, C.I. Acid Yellow 17, 23, 42, 44, 79, and 142, C.I. Acid Red 52, 80, 82, 249, 254, and 289, C.I. Acid Blue 9, 45, and 249, C.I. Acid Black 1, 2, 24, and 94, C. I. Food Black 1 and 2, C.I. Direct Yellow 1, 12, 24, 33, 50, 55, 58, 86, 132, 142, 144, and 173, C.I. Direct Red 1, 4, 9, 80, 81, 225, and 227, C.I. Direct Blue 1, 2, 15, 71, 86, 87, 98, 165, 199, and 202, C.I. Direct Black 19, 38, 51, 71, 154, 168, 171, and 195, C.I. Reactive Red 14, 32, 55, 79, and 249, and C.I. Reactive Black 3, 4, and 35.

The content of the colorant in the ink composition is preferably 0.1% by mass or more and 15% by mass or less, more preferably 0.5% by mass or more and 12.5% by mass or less, and even more preferably 1% by mass or more and 10% by mass or less, from the viewpoints of improving image density, achieving favorable fixability, and discharge stability.

It is noted that the pigment may be dispersed to provide the ink by any of the following methods: introducing a hydrophilic functional group to the pigment to make the self-dispersible pigment; covering the surface of the pigment with a resin to be dispersed; or dispersing the pigment by a dispersant.

An example of a method of introducing a hydrophilic functional group to the pigment to make the self-dispersible pigment includes adding a functional group such as a sulfone group and a carboxyl group to the pigment (for example, carbon) to make the pigment dispersible in water.

An example of a method of covering the surface of the pigment with a resin to be dispersed includes incorporating the pigment in a microcapsule to make the pigment dispersible in water. In such a pigment covered with a resin, not all the pigment included in the ink should be covered with a resin, and the pigment not covered with any resin or the pigment partially covered with a resin may be dispersed in the ink as long as the effects of the present disclosure are not inhibited.

A method of dispersing the pigment by a dispersant includes a method of dispersing the pigment with well-known low-molecular dispersants and high-molecular dispersants, represented by surfactants.

Examples of the dispersants include, but are not limited to: anionic surfactants, cationic surfactants, amphoteric surfactants, nonionic surfactants, nonionic surfactants (RT-100 manufactured by Takemoto Oil & Fat Co., Ltd.), and sodium naphthalene sulfonate formalin condensate other than the surfactant used in the present disclosure.

The dispersants may be used alone or in combination of two or more types.

An ink may be obtained by mixing the pigment with other materials such as water and an organic solvent. An ink may also be made by, first, preparing a pigment dispersion by mixing a pigment with water, a dispersant, and the like, and thereafter mixing the pigment dispersion with other materials such as water and an organic solvent.

Such a pigment dispersion is obtained by mixing and dispersing water, a pigment, a pigment dispersant, and optionally other components, and then adjusting the particle diameter. It is noted that a disperser may be used to disperse the components.

The particle diameter of the pigment in the pigment dispersion is not particularly limited, but the maximum frequency in the maximum number conversion is preferably 20 nm or more and 500 nm or less, more preferably 20 nm or more and 150 nm or less, for achieving a good dispersion stability of the pigment and for enhancing discharge stability and image quality such as image density. The particle diameter of the pigment may be measured using a particle size analyzer (for example, Nanotrac” Wave-UT151, manufactured by MicrotracBEL Corp.).

The content of the pigment in the pigment dispersion is not particularly limited and may be appropriately selected depending on the intended use, but is preferably 0.1% by mass or more and 50% by mass or less, more preferably 1% by mass or more and 40% by mass or less, for achieving a good dispersion stability and enhancing image density.

Preferably, the pigment dispersion is optionally subjected to filtration using a filter, a centrifugal separator, or the like to remove coarse particles, followed by degassing.

### <Resin>

A type of the resin is not particularly limited and may be appropriately selected depending on the intended use. Examples of the resin include, but are not limited to, urethane resins, polyester resins, acrylic resins, vinyl acetate resins, styrenic resins, butadiene resins, styrene-butadiene resins, vinyl chloride resins, acrylic styrene resins, and acrylic silicone resins.

Resin particles including such resins may also be used. The resin particles may be dispersed in water serving as a dispersion medium to prepare a resin emulsion. An ink can be obtained by mixing the resin emulsion with other materials such as a colorant and an organic solvent. Such resin particles are available accordingly either synthetically or commercially. The resin particles may be used alone or in combination of two or more types of resin particles.

The volume average particle diameter of the resin particles is not particularly limited and may be appropriately selected depending on the intended use. However, to obtain a good fixability and high image hardness, the volume average particle diameter is preferably 10 nm or more and 1,000 nm or less, more preferably 10 nm or more and 200 nm or less, and even more preferably 10 nm or more and 100 nm or less. The volume average particle diameter may be measured, for example, using a particle size analyzer (for example, Nanotrac^{□} Wave-UT151, manufactured by MicrotracBEL Corp.).

The content of the resin in the ink composition is not particularly limited and may be appropriately selected depending on the intended use, but from the viewpoint of fixability and ink storage stability, it is preferably 1% by mass or more and 30% by mass or less, more preferably 10% by mass or more and 23% by mass or less, and even more preferably 20% by mass or more and 25% by mass or less, relative to the total amount of the ink.

It is noted that the solid content in the ink composition is mainly derived from the resin.

The particle diameter of the solid content in the ink composition is not particularly limited and may be appropriately selected depending on the intended use. However, from the viewpoint of enhancing discharge stability and image quality such as image density, the maximum frequency in maximum number conversion preferably is 20 nm or more and 1000 nm or less, and more preferably 20 nm or more and 150 nm or less. The solid contents include the resin particles and pigment particles. The particle diameter may be measured using a particle size analyzer (for example, Nanotrac^{□} Wave-UT151, manufactured by MicrotracBEL Corp.).

The total solid content in the ink composition is 5% by mass or more and 15% by mass or less, preferably 5.5% by mass or more and 14% by mass or less, and even more preferably 6% by mass or more and 13% by mass or less. When the total solid content in the ink composition is within such a range, both the drying properties of ink droplets landing on a recording sheet and the blur quality of the image may be made compatible. It is noted that if the total solid content in the ink composition is less than 5% by mass, ink droplets after landing have a poor image blur quality on the paper surface. If the content exceeds 15% by mass, when the total solid content is increased, the drying property of the ink droplets increases, and the image coverage efficiency deteriorates because the dots fix on the recording sheet before the dots spread, resulting in a decrease in image density.

### <Surfactant>

As a surfactant included in the ink composition of the present disclosure, an acetylene-based surfactant containing a compound represented by the following formula (1) is used.

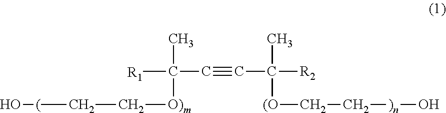

It is noted that in the formula (1), R₁ and R₂ each independently represent an alkyl group. n and m each independently represent an integer.

The alkyl groups represented by R₁ and R₂ in the above Formula (1) preferably have one to five carbon atoms, and more preferably three to five carbon atoms, from the viewpoint of balancing between the hydrophobicity and hydrophilicity of the surfactant. If the number of carbon atoms is six or more, the hydrophobicity of the surfactant becomes too strong, which may cause separation in the ink composition.

The integers represented by n and m in the above formula (1) represent the addition number of ethylene oxide structures. The addition amount of ethylene oxide structures in the molecule is preferably 50% by mass or more and 80% by mass or less. When the mass in the molecule is less than 50% by mass, the hydrophobicity of the surfactant becomes strong, which may cause separation in the ink composition. On the other hand, when the mass in the molecule is greater than 80% by mass, the hydrophobicity of the surfactant weakens and its affinity for the recording sheet decreases, which may reduce the wettability on the recording sheet surface. From the viewpoint of the addition amount, the addition numbers n and m of the ethylene oxide structure are preferably 2 or more and 7 or less.

If the acetylene-based surfactant containing the compound represented by the above Formula (1) is employed, the wetting and spreading properties of the ink droplet on the recording sheet are improved, and the coverage efficiency of the ink film at a low deposition amount is enhanced. This makes it possible to achieve both drying properties and image quality.

Among the compounds represented by the above Formula (1), a compound represented by the following Formula (2) is preferable.

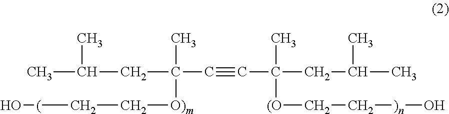

In the above formula (2), n and m each independently represent an integer, and preferably indicate the addition number of ethylene oxide structures.

Commercial products can be employed for the above-mentioned acetylene-based surfactant. Examples of the acetylene-based surfactant include, but are not limited to, Acetylenol^{□} E60, Acetylenol E100 (both manufactured by Kawaken Fine Chemicals Co., Ltd.), Surfynol^{□} 420, Surfynol 465, and Olfine^{□} E1010 (all manufactured by Nissin Chemical Industry Co., Ltd.).

An amphoteric surfactant, an anionic surfactant, a nonionic surfactant, a silicone-based surfactant, or a fluorine-based surfactant may be optionally used in combination. Each of such surfactants may be used alone or in combination of two or more types. Examples of the amphoteric surfactant include, but are not limited to, laurylaminopropionate, lauryl dimethyl betaine, stearyl dimethyl betaine, and lauryl hydroxyethyl betaine.

Examples of the anionic surfactant include, but are not limited to, polyoxyethylene alkyl ether acetate, dodecylbenzene sulfonate, lauryl sulfate, and polyoxyethylene alkyl ether sulfate.

Examples of the nonionic surfactant include, but are not limited to, polyoxyethylene alkyl phenyl ethers, polyoxyethylene alkyl esters, polyoxyethylene alkylamines, polyoxyethylene alkylamides, polyoxyethylene propylene block polymers, sorbitan fatty acid esters, polyoxyethylene sorbitan fatty acid esters, and ethylene oxide adducts of acetylene alcohol.

The silicone-based surfactant is not particularly limited and may be appropriately selected depending on the intended use. Examples of the silicone-based surfactant include, but are not limited to, side-chain modified polydimethylsiloxanes, both-end modified polydimethylsiloxanes, mono-end modified polydimethylsiloxanes, and side-chain and both-end modified polydimethylsiloxanes. A polyether-modified silicone-based surfactant having a polyoxyethylene group or a polyoxyethylene polyoxypropylene group as a modifying group is particularly preferable because such a group exhibits favorable properties as an aqueous surfactant.

Such a silicone-based surfactant is available accordingly either synthetically or commercially. Commercial products are available, for example, from BYK-Chemie GmbH, Shin-Etsu Chemical Co., Ltd., Dow Corning Toray Co., Ltd., Nippon Emulsion Co., Ltd., and Kyoeisha Chemical Co., Ltd.

The above-mentioned polyether-modified silicone-based surfactant is not particularly limited and may be appropriately selected depending on the intended use. Examples of the polyether-modified silicone-based surfactant include, but are not limited to, those having a polyalkylene oxide structure introduced into the Si side chain of the dimethylpolysiloxane, represented by the following general formulas (3) and (4).

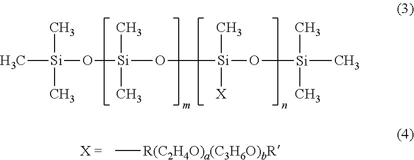

It is noted that in the above general formulas (3) and (4), m, n, a, and b each independently represent an integer, R represents an alkylene group, and R′ represents an alkyl group.

Commercial products may be employed for the above-mentioned polyether-modified silicone-based surfactant. Examples of the polyether-modified silicone-based surfactant include, but are not limited to, KF-618, KF-642, KF-643 (all manufactured by Shin-Etsu Chemical Co., Ltd.), EMALEX^{□}-SS-5602, SS-1906EX (both manufactured by Nippon Emulsion Co., Ltd.), FZ-2105, FZ-2118, FZ-2154, FZ-2161, FZ-2162, FZ-2163, FZ-2164 (all manufactured by Dow Corning Toray Co., Ltd.), BYK^{␣}-33, BYK-387 (BYK-Chemie GmbH), and TSF4440, TSF4452, TSF4453 (all manufactured by Toshiba Silicone Co., Ltd.).

Examples of the fluorine-based surfactants include, but are not limited to, perfluoroalkyl sulfonic acid compounds, perfluoroalkyl carboxylic acid compounds, perfluoroalkyl phosphate ester compounds, perfluoroalkyl ethylene oxide adducts, and polyoxyalkylene ether polymer compounds having a perfluoroalkyl ether group in the side chain.

Examples of the perfluoroalkyl sulfonic acid compounds include, but are not limited to, perfluoroalkyl sulfonic acid and perfluoroalkyl sulfonate. Examples of the perfluoroalkyl carboxylic acid compounds include, but are not limited to, perfluoroalkyl carboxylic acid and perfluoroalkyl carboxylate. Examples of the polyoxyalkylene ether polymer compounds having a perfluoroalkyl ether group in the side chain include, but are not limited to, a sulfuric ester salt of a polyoxyalkylene ether polymer having a perfluoroalkyl ether group in the side chain, and a salt of a polyoxyalkylene ether polymer having a perfluoroalkyl ether group in the side chain. Examples of the counter ions for in such fluorine-based surfactants include, but are not limited to, Li, Na, K, NH₄, NH₃CH₂CH₂OH, NH₂ (CH₂CH₂OH)₂, and NH(CH₂CH₂OH)₃.

Among these, polyoxyalkylene ether polymer compounds having a perfluoroalkyl ether group in the side chain are preferable because these exhibit low foaming properties, and particularly preferable are the fluorine-based surfactants represented by the following general formula (5) and the following general formula (6).

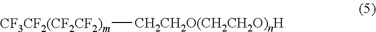

In the compound represented by the above general formula (5), to impart water solubility, m is preferably an integer from 0 to 10, and n is preferably an integer from 0 to 40.

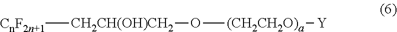

In the compound represented by the above general formula (6), Y is H, CₘF₂ₘ₊₁ where m is an integer from 1 to 6, CH₂CH(OH) CH₂-CₘF₂ₘ₊₁ where m is an integer from 4 to 6, or CₚH₂ₚ₊₁ where p is an integer from 1 to 19. n is an integer from 1 to 6. a is an integer from 4 to 14.

The fluorine-based surfactants may be Commercial products. Examples of such commercial products include, but are not limited to, Surflon S-111, S-112, S-113, S-121, S-131, S-132, S-141, S-145 (all manufactured by Asahi Glass Co., Ltd.); Fluorad FC-93, FC-95, FC-98, FC-129, FC-135, FC-170C, FC-430, FC-431 (all manufactured by Sumitomo 3M Ltd.); Megafac-F-470, F-1405, F-474 (all manufactured by Dainippon Ink and Chemicals, Inc.); Zonyl TBS, FSP, FSA, FSN-100, FSN, FSO-100, FSO, FS-300, UR, Capstone FS-30, FS-31, FS-3100, FS-34, FS-35 (all manufactured by Chemours Company); FT-110, FT-250, FT-251, FT-400S, FT-150, FT-400SW (all manufactured by Neos Co., Ltd.), PolyFox PF-136A, PF-156A, PF-151N, PF-154, PF-159 (all manufactured by Omnova Solutions), and Unidyne⁻DSN-403N (manufactured by Daikin Industries, Ltd.).

Such fluorine-based surfactants, amphoteric surfactants, anionic surfactants, and silicone-based surfactants may each be used alone or in combination of two or more types.

The content of the surfactant in the ink composition is not particularly limited and may be appropriately selected depending on the intended use. It is noted that from the viewpoint of excellent wettability and discharge stability, and improved image quality, the content of the surfactant in the ink composition is preferably 0.001% by mass or more and 5% by mass or less, more preferably 0.01% by mass or more and 3% by mass or less, and still more preferably 0.3% by mass or more and 1.5% by mass or less.

### [Additives]

As additives, a defoamer, a preservative and fungicide, a rust inhibitor, a pH adjuster, and the like may be optionally used.

Examples of the defoamer include, but are not limited to, silicone-based defoamers, polyether-based defoamers, and fatty-acid-ester-based defoamers. Each of such defoamers may be used alone or in combination of two or more types. Among such defoamers, silicone-based defoamers are preferred to achieve an excellent defoaming effect.

Examples of the preservative and fungicide include, but are not limited to, 1,2-benzisothiazoline-3-one.

Examples of the rust inhibitor include, but are not limited to, acid sulphite and sodium thiosulfate.

The pH adjuster is not particularly limited as long as the pH adjuster can adjust pH to 7 or higher. Examples of the pH adjuster include, but are not limited to, amines such as diethanolamine and triethanolamine.

### <Discharge of Ink Composition>

A method for discharging an ink is not particularly limited and may be appropriately selected. Examples of methods for applying an ink include, but are not limited to, an inkjet method, a blade coating method, a gravure coating method, a bar coating method, a roll coating method, a dip coating method, a curtain coating method, a slide coating method, a die coating method, and a spray coating method. Among such methods, the inkjet method is preferable from the viewpoint of ink discharge stability, fine image formation, and productivity.

### <Recording Apparatus and Recording Method>

An image forming apparatus according to the present disclosure may utilize various recording devices, such as a printer, a facsimile machine, a copying machine, a printer/fax/copier multi-function peripheral (MFP), and a three-dimensional modeling device. When an ink is applied by the above-mentioned inkjet method, the recording apparatus based on the inkjet recording system is used. A recording apparatus based on the inkjet recording system will be described below as an example of a recording apparatus.

### <Discharge Head>

In the present disclosure, the recording apparatus refers to an apparatus that includes a discharge head that discharges the ink composition onto a recording substrate and can discharge an ink or various treatment liquids onto the recording substrate from the discharge head. The recording method refers to a method of performing recording on a recording medium using such a recording apparatus. Here, “recording” means that the ink or various treatment liquids can deposit onto the recording substrate, even temporarily. The recording medium is an example of the recording substrate.

Such a recording apparatus may include not only a discharge head that discharges an ink, but also a heating means, a drying means, a means related to the feeding, conveying, and discharging of the recording medium, a pre-treatment device, and a post-treatment device.

Examples of the heating means and the drying means include, but are not limited to, devices for heating and drying the printed surface and the reverse surface of a recording medium. The heating means and the drying means are not particularly limited. Examples of the heating means and the drying means include, but are not limited to, a fan heater and an infrared heater. The heating and the drying may be performed, for example, before, during, or after printing.

The recording apparatus includes both a serial-type device in which the discharge head is moved and a line-type device in which the discharge head is not moved, unless otherwise specified.

Such a recording apparatus includes not only a desktop type but also a wide-format recording apparatus that can print on a recording medium having, for example, AO size, and a continuous form printer that can use a continuous sheet wound into a roll as a recording medium.

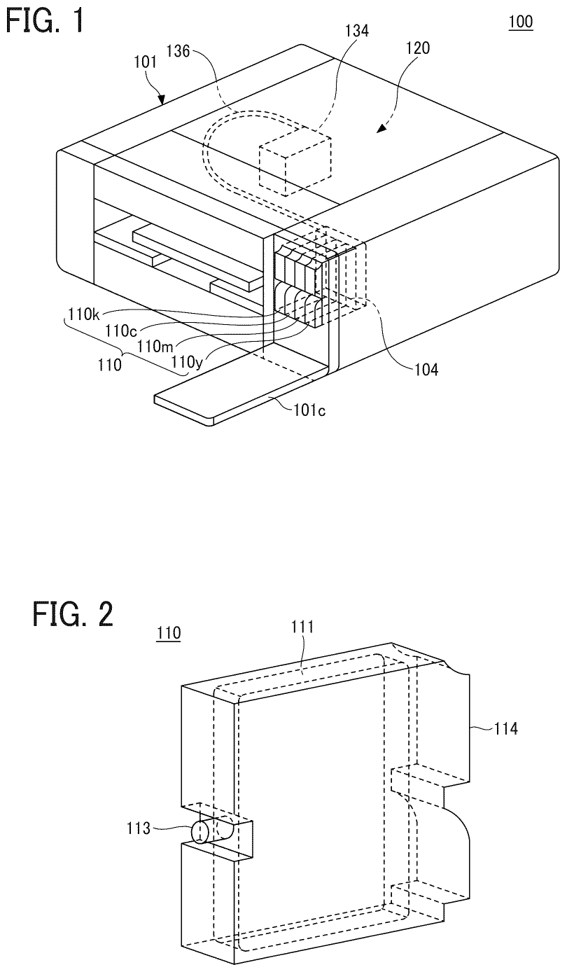

A recording apparatus, which is an example of the image forming apparatus according to the present disclosure, will be described with reference to FIG. 1 and FIG. 2. FIG. 1 illustrates an example of the apparatus. FIG. 2 illustrates an example of a main tank in the recording apparatus. The recording apparatus is, for example, a serial-type image forming apparatus.

A recording apparatus 100 includes an exterior 101 and a mechanism unit 120 provided inside the exterior 101.

For example, an ink container 111 of a main tank 110 (110k, 110c, 110m, 110y) for each color such as black (K), cyan (C), magenta (M), and yellow (Y), is formed of a packaging member such as an aluminum laminate film.

The ink container 111 is contained in a storage container case 114 made of plastic, for example. Thus, the main tank 110 is employed for an ink cartridge for each color.

It is noted that the ink for each color is not limited to black (K), cyan (C), magenta (M), and yellow (Y), but may be other inks such as white ink, metallic ink, or clear ink. The same applies to the main tank 110 and the ink container 111 for each color.

A cartridge holder 104 is provided on a back side of an opening when a cover 101c of an apparatus main body is opened. The main tank 110 is detachably attached to the cartridge holder 104. Therefore, each ink discharge port 113 of the main tank 110 and a discharge head 134 for each color communicate with each other via a supply tube 136 for each color, and an ink may be discharged from the discharge head 134 onto a recording medium.

Alternatively, the main tank 110 and the ink container 111 for each color may be filled with a pre-treatment liquid or a post-treatment liquid instead of ink, and the pre-treatment liquid or the post-treatment liquid may be discharged onto the recording medium from the discharge head 134. The discharge head 134 is preferably an inkjet head. For example, a nozzle used in a well-known inkjet printer may be employed for the nozzle in the head unit of the discharge head 134. The discharge head 134 is an example of the discharge head in the present disclosure.

The recording apparatus may further optionally include, in addition to the head portion that discharges an ink, devices relating to feeding, conveying, and discharging of the recording medium, and other devices referred to as a pre-treatment device or a post-treatment device.

One aspect of the pre-treatment device and the post-treatment device includes an aspect in which a liquid container containing a pre-treatment liquid and a post-treatment liquid and a liquid discharge head are included additionally, and the pre-treatment liquid and the post-treatment liquid are discharged according to an inkjet recording system, similarly to a case of black (K), cyan (C), magenta (M), and yellow (Y) ink.

Another aspect of the pre-treatment device and the post-treatment device includes an aspect in which the pre-treatment device and the post-treatment device according to a blade coating method, a roll coating method, or a spray coating method other than the inkjet recording method are provided.

In the recording apparatus 100, the ink composition is discharged by a discharge head under a condition where the deposition amount of the ink composition is 0.6 μL/cm² or less when printing an image on a recording medium at a droplet count of 1200×1200 dpi.

In the recording apparatus 100, the drying properties of landed ink droplets may be improved by setting the deposition amount of the ink composition to a range of 0.6 μL/cm² or less when printing an image at a droplet count of 1200×1200 dpi. It is noted that from the viewpoint of image density and chroma, the deposition amount of the ink composition is preferably 0.4 μL/cm² or more and 0.5 μL/cm² or less. If the ink deposition amount is more than 0.6 μL/cm², the fastness of an image may possibly deteriorate due to inferior drying properties.

In the recording apparatus 100, the volume of ink droplets discharged by the discharge head may be 1 pL or more and 5 pL or less. In the recording apparatus 100, the ink droplets having the volume of 1 pL or more and 5 pL or less can suppress bleeding due to the droplet volume being in such a small range.

### EXAMPLES

The present disclosure will be described more specifically below by providing Examples and Comparative Examples, however, the present disclosure is not limited to these Examples. It is noted that in the following, numerical values without units are expressed in % by mass.

### [Preparation of Ink Composition]

An organic solvent, a surfactant, and water were premixed according to the formulation presented in Table 1.

### <Preparation of Pigment Dispersion>

After premixing according to the formulation presented in Table 1, 2% by mass of an anionic surfactant (Pionin A-51-B, manufactured by Takemoto Oil & Fat Co., Ltd.), 13.6% by mass of C.I. Pigment Black 7, and ion-exchanged water were mixed, and circulated and dispersed for seven hours using a disk-type bead mill (KDL model, manufactured by Shinmaru Enterprises; media: 0.3 mm diameter zirconia balls used) to obtain a pigment dispersion (Black Dispersion A). It is noted that “balance” for the ion-exchanged water (high-purity water) indicates the amount necessary for the total of all components of the ink composition included in the dispersion to be 100% by mass.

### <Preparation of Acrylic Resin Emulsion A>

Acrylic Resin Emulsion A (TOCRYL W168, manufactured by Toyo Chem Co., Ltd.) was employed for the resin (Resin Content: 49.5% by mass).

### <Formulation of Acrylic Resin Emulsion B>

Acrylic Resin Emulsion B (TOCRYL BCX-8111, manufactured by Toyo Chem Co., Ltd.) was used (Resin Content: 50% by mass).

### <Preparation of Urethane Resin Emulsion A>

Urethane Resin Emulsion A (SF-460, manufactured by Dai-ichi Kogyo Seiyaku Co., Ltd.) was used (Resin Content: 30% by mass).

### <Preparation of Urethane Resin Emulsion B>

Urethane Resin Emulsion B(SF-820, manufactured by Dai-ichi Kogyo Seiyaku Co., Ltd.) was used (Resin Content: 30.2% by mass).

### <Preparation of Surfactants>

As acetylene-based surfactants, Acetylenol E40, Acetylenol E60, Acetylenol E100 (all manufactured by Kawaken Fine Chemicals Co., Ltd.), Surfynol^{□}420, Surfynol 440, and Surfynol 465 (all manufactured by Nissin Chemical Industry Co., Ltd.) were employed. For comparison, Silface″ SAG016, Silface SAG020 (both manufactured by Nissin Chemical Industry Co., Ltd.) were employed for polyether-modified silicone-based surfactants, and Neugen^{□}-SD-30, Neugen SD-70 (both manufactured by Dai-ichi Kogyo Seiyaku Co., Ltd.) were employed for polyoxyethylene tridecyl ether surfactants.

### Preparation of Production Example 1

Production Example 1 of a black ink was prepared by mixing the Black Dispersion A, Acrylic Resin Emulsion A, and Urethane Resin Emulsion A obtained above with the following components. It is noted that “balance” for the pure water (high-purity water) indicates the amount necessary for the total of all components constituting the ink to be 100% by mass.
Black Dispersion A (Pigment Content 15.0% by mass): 14.3% by mass
Acrylic Resin Emulsion A 6.28% by mass
Urethane Resin Emulsion A 0.79% by mass
Isoprene Glycol 11% by mass
3-Methoxy-3-methyl-1-butanol 3% by mass
Propylene Glycol Monomethyl Ether 1% by mass
Acetylenol E60 (manufactured by Kawaken Fine Chemicals Co., Ltd.) 0.5% by mass
Pure Water: Balance

### Preparation of Production Examples 2 to 15

Production Examples 2 to 15 of black ink were produced in much the same manner as Production Example 1 except that the materials and contents were changed according to the materials and the contents presented in Table 1.

### <Inkjet Printing>

Production Example 1 of the black ink was filled into an ink cartridge of an inkjet printer (a modified machine of GXe5500, manufactured by Ricoh Co., Ltd.). The ink cartridge filled with the ink was loaded into the inkjet printer, and inkjet printing was performed using Aqueous Ink A (Black Dispersion A). The inkjet printer included a heater (temperature control controller MTCD, manufactured by MISUMI Corporation) that could heat the recording medium from the back side before, during, and after printing. This enabled printing on the recording medium heated by the heater before and during printing, and allowed for heating and drying the printed matter by the heater after printing.

### <Recording Sheet>

As the recording sheet, coated paper (OKTop, manufactured by Oji Paper Co., Ltd.) was used.

### <Printing Conditions>

In printing, the heating temperatures of heaters (heating means) arranged before, during, and after printing were set to 45° C., 45° C., and 60° C., respectively, and a solid image with an image resolution of 1200 dpi×1200 dpi and a printing rate of 100% was printed. At this time, the amount of deposition on the recording sheet was changed by adjusting the printing conditions of the inkjet printer. Table 2 presents the printing conditions for the Examples and Comparative Examples.

TABLE 1

| | | Boiling | Production | Production | Production | Production | Production |
|---|---|---|---|---|---|---|---|
| | Material Name | Point | Ex. 1 | Ex. 2 | Ex. 3 | Ex. 4 | Ex. 5 |
| Organic | 1,2-PD (by Tokyo Chemical Industry Co., | 188 | | | | | |
| solvent | Ltd.) | | | | | | |
| | 1,2-BD (by Shinko Organic Chemical | 194 | | | | | |
| | Industry) | | | | | | |
| | 1,2-HD (by Tokyo Chemical Industry Co., | 196 | | | | | |
| | Ltd.) | | | | | | |
| | Octanediol (by KH Neochem) | 244 | | | 13 | 15 | |
| | Isoprene glycol (by Kuraray Co., Ltd.) | 203 | 11 | 19 | | | 15 |
| | 3-methoxy-3-methyl-1-butanol | 173 | 3 | | 2 | | |
| | (by Kuraray Co., Ltd.) | | | | | | |
| | Propylene glycol monomethyl ether | 120 | 1 | | 3 | | 1 |
| | (by Kanto Chemical Co., Inc.) | | | | | | |
| | Ethylene glycol monobutyl ether | 168 | | | | 1 | 3 |
| | (by Tokyo Chemical Industry Co., Ltd.) | | | | | | |
| | Dipropylene glycol monomethyl ether | 190 | | | | | |
| | (by Kanto Chemical Co., Inc.) | | | | | | |
| Surface | Acetylenol E40 (by Kawaken Fine | | | | | | |
| surfactant | Chemicals Co., Ltd.) | | | | | | |
| | Acetylenol E60 (by Kawaken Fine | | 0.5 | | 0.5 | | 1 |
| | Chemicals Co., Ltd.) | | | | | | |
| | Acetylenol E100 (by Kawaken Fine | | | 0.8 | | | |
| | Chemicals Co., Ltd.) | | | | | | |
| | Surfynol 420 (by Nissin Chemical Industry | | | | | | |
| | Co., Ltd.) | | | | | | |
| | Surfynol 440 (by Nissin Chemical Industry | | | | | | |
| | Co., Ltd.) | | | | | | |
| | Surfynol 465 (by Nissin Chemical Industry | | | | | 0.9 | |
| | Co., Ltd.) | | | | | | |
| | SILFACE SAG016 (by Nissin Chemical | | | | | | |
| | Industry Co., Ltd.) | | | | | | |
| | SILFACE SAG020 (by Nissin Chemical | | | | | | |
| | Industry Co., Ltd.) | | | | | | |
| | Noigen SD-30 (by Daiichi Kogyo Seiyaku) | | | | | | |
| | Noigen SD-70 (by Daiichi Kogyo Seivaku) | | | | | | |
| Water | High-purity water | | Balance | Balance | Balance | Balance | Balance |
| Resin | TOCRYL W168 (by Toyochem) | | 6 | | 6 | | 7 |
| | TOCRYL BCX-8111 (by Toyochem) | | | 6 | | 3 | |
| | SF-460 (by Daiichi Kogyo Seiyaku) | | 1 | 1 | | 3 | 5 |
| | SF-820 (by Daiichi Kogyo Seiyaku) | | | | 3 | | |
| Pigment | Black dispersion | | 36 | 36 | 36 | 36 | 36 |
| dispersion | | | | | | | |
| Total | | | 100 | 100 | 100 | 100 | 100 |

| | | Production | Production | Production | Production | Production |
|---|---|---|---|---|---|---|
| | Material Name | Ex.6 | Ex. 7 | Ex. 8 | Ex. 9 | Ex. 10 |
| Organic | 1,2-PD (by Tokyo Chemical Industry Co., | | 11 | | | |
| solvent | Ltd.) | | | | | |
| | 1,2-BD (by Shinko Organic Chemical | | | | | 15 |
| | Industry) | | | | | |
| | 1,2-HD (by Tokyo Chemical Industry Co., | | | 15 | | |
| | Ltd.) | | | | | |
| | Octanediol (by KH Neochem) | | | | | |
| | Isoprene glycol (by Kuraray Co., Ltd.) | 17 | | | 15 | |
| | 3-methoxy-3-methyl-1-butanol | 1 | 1 | | | 2 |
| | (by Kuraray Co., Ltd.) | | | | | |
| | Propylene glycol monomethyl ether | | 1 | 2 | 5 | 1 |
| | (by Kanto Chemical Co., Inc.) | | | | | |
| | Ethylene glycol monobutyl ether | | | 1 | | |
| | (by Tokyo Chemical Industry Co., Ltd.) | | | | | |
| | Dipropylene glycol monomethyl ether | 1 | | | | |
| | (by Kanto Chemical Co., Inc.) | | | | | |
| Surface | Acetylenol E40 (by Kawaken Fine | | | | 0.6 | |
| surfactant | Chemicals Co., Ltd.) | | | | | |
| | Acetylenol E60 (by Kawaken Fine | | | | | |
| | Chemicals Co., Ltd.) | | | | | |
| | Acetylenol E100 (by Kawaken Fine | | | | | |
| | Chemicals Co., Ltd.) | | | | | |
| | Surfynol 420 (by Nissin Chemical Industry | 0.6 | | | | |
| | Co., Ltd.) | | | | | |
| | Surfynol 440 (by Nissin Chemical Industry | | | 0.6 | | |
| | Co., Ltd.) | | | | | |
| | Surfynol 465 (by Nissin Chemical Industry | | 0.1 | | | |
| | Co., Ltd.) | | | | | |
| | SILFACE SAG016 (by Nissin Chemical | | | | | 1 |
| | Industry Co., Ltd.) | | | | | |
| | SILFACE SAG020 (by Nissin Chemical | | | | | |
| | Industry Co., Ltd.) | | | | | |
| | Noigen SD-30 (by Daiichi Kogyo Seiyaku) | | | | | |
| | Noigen SD-70 (by Daiichi Kogyo Seivaku) | | | | | |
| Water | High-purity water | Balance | Balance | Balance | Balance | Balance |
| Resin | TOCRYL W168 (by Toyochem) | 8 | 6 | 11 | 4 | 6 |
| | TOCRYL BCX-8111 (by Toyochem) | | | | | |
| | SF-460 (by Daiichi Kogyo Seiyaku) | 2 | 1 | 5 | | 1 |
| | SF-820 (by Daiichi Kogyo Seiyaku) | | | | 2 | |
| Pigment | Black dispersion | 36 | 36 | 44 | 36 | 36 |
| dispersion | | | | | | |
| Total | | 100 | 100 | 100 | 100 | 100 |
| | | Production | Production | Production | Production | Production |
| | Material Name | Ex. 11 | Ex. 12 | Ex. 13 | Ex. 14 | Ex. 15 |
| Organic | 1,2-PD (by Tokyo Chemical Industry Co., | | | | | |
| solvent | Ltd.) | | | | | |
| | 1,2-BD (by Shinko Organic Chemical | | | 15 | | |
| | Industry) | | | | | |
| | 1,2-HD (by Tokyo Chemical Industry Co., | | | | | |
| | Ltd.) | | | | | |
| | Octanediol (by KH Neochem) | 21 | | | | 17 |
| | Isoprene glycol (by Kuraray Co., Ltd.) | | 15 | | 8 | |
| | 3-methoxy-3-methyl-1-butanol | 1 | 3 | | 3 | |
| | (by Kuraray Co., Ltd.) | | | | | |
| | Propylene glycol monomethyl ether | | 1 | | 4 | |
| | (by Kanto Chemical Co., Inc.) | | | | | |
| | Ethylene glycol monobutyl ether | 1 | | | | 2 |
| | (by Tokyo Chemical Industry Co., Ltd.) | | | | | |
| | Dipropylene glycol monomethyl ether | | | 3 | | |
| | (by Kanto Chemical Co., Inc.) | | | | | |
| Surface | Acetylenol E40 (by Kawaken Fine | | | | | |
| surfactant | Chemicals Co., Ltd.) | | | | | |
| | Acetylenol E60 (by Kawaken Fine | 0.8 | | | | |
| | Chemicals Co., Ltd.) | | | | | |
| | Acetylenol E100 (by Kawaken Fine | | 0.5 | | | |
| | Chemicals Co., Ltd.) | | | | | |
| | Surfynol 420 (by Nissin Chemical Industry | | | | | |
| | Co., Ltd.) | | | | | |
| | Surfynol 440 (by Nissin Chemical Industry | | | | | |
| | Co., Ltd.) | | | | | |
| | Surfynol 465 (by Nissin Chemical Industry | | | | | |
| | Co., Ltd.) | | | | | |
| | SILFACE SAG016 (by Nissin Chemical | | | | | |
| | Industry Co., Ltd.) | | | | | |
| | SILFACE SAG020 (by Nissin Chemical | | | | | 0.6 |
| | Industry Co., Ltd.) | | | | | |
| | Noigen SD-30 (by Daiichi Kogyo Seiyaku) | | | 0.7 | | |
| | Noigen SD-70 (by Daiichi Kogyo Seivaku) | | | | 0.9 | |
| Water | High-purity water | Balance | Balance | Balance | Balance | Balance |
| Resin | TOCRYL W168 (by Toyochem) | 6 | 3 | 6 | 6 | 6 |
| | TOCRYL BCX-8111 (by Toyochem) | | | | | |
| | SF-460 (by Daiichi Kogyo Seiyaku) | | 1 | 1 | 1 | |
| | SF-820 (by Daiichi Kogyo Seiyaku) | 3 | | | | 1 |
| Pigment | Black dispersion | 36 | 20.6 | 36 | 36 | 36 |
| dispersion | | | | | | |
| Total | | 100 | 100 | 100 | 100 | 100 |

### <Evaluation Method>

### <Image Density>

The image density (OD) of the image, which was allowed to stand at room temperature for 24 hours after the aforementioned inkjet printing, was measured by using a spectrophotometer (xRite, manufactured by PANTONE), and evaluated according to the following criteria. In the evaluation criteria, “Good” or better was considered a practical range, and “Excellent” was considered preferable. The evaluation results for the Examples and Comparative Examples are presented in Table 2.

### (Evaluation Criteria)

Excellent: 1.8 or higher

Good: 1.5 or higher and less than 1.8

Poor: Less than 1.5

### <Beading>

The image after the aforementioned inkjet printing was observed to confirm the presence or absence of granularity (beading), and evaluated according to the following criteria. In the evaluation criteria, “Good” or better was considered a practical range, and “Excellent” was considered preferable. The evaluation results for the Examples and Comparative Examples are presented in Table 2.

### (Evaluation Criteria)

Excellent: Beading is not confirmed when observing the image from a distance of 300 mm.

Good: Beading is confirmed when observing the image from a distance of 300 mm.

Poor: Beading is confirmed when observing the image from a distance of 1000 mm.

### <Drying Property>

The image after the aforementioned inkjet printing was cut into strips, and the printed image surfaces were overlaid, subjected to a load of 0.5 kg/cm², and left to stand overnight at 25° C. in a 50% environment. After the overnight period, the load was removed, and the image when peeling apart the overlaid recording substrates was evaluated according to the following criteria. In the evaluation criteria, “Good” or better was considered a practical range, and “Excellent” was considered preferable. The evaluation results for the Examples and Comparative Examples are presented in Table 2.

### (Evaluation Criteria)

Excellent: Peeling of the image is not visually observed when observing the adhered surface from a distance of 300 mm.

Good: Peeling of the image is visually observed when observing the adhered surface from a distance of 300 mm.

Poor: Peeling of the image is visually observed when observing the adhered surface from a distance of 1000 mm.

TABLE 2

| | | Deposition | | | | |
|---|---|---|---|---|---|---|
| | | Amount | Resolution | | | Drying |
| Examples | Production Ex. | [uL/cm²] | [dpi] | Image Density | Beading | Property |
| Ex. 1 | Production Ex. 1 | 0.4 | 1200 × 1200 | Excellent | Excellent | Excellent |
| Ex. 2 | Production Ex. 2 | 0.4 | 1200 × 1200 | Excellent | Good | Excellent |
| Ex. 3 | Production Ex. 3 | 0.5 | 1200 × 1200 | Excellent | Excellent | Excellent |
| Ex. 4 | Production Ex. 4 | 0.4 | 1200 × 1200 | Excellent | Excellent | Excellent |
| Ex. 5 | Production Ex. 5 | 0.5 | 1200 × 1200 | Excellent | Good | Excellent |
| Ex. 6 | Production Ex. 6 | 0.4 | 1200 × 1200 | Good | Excellent | Excellent |
| Com. Ex. 1 | Production Ex. 7 | 0.4 | 1200 × 1200 | Poor | Excellent | Excellent |
| Com. Ex. 2 | Production Ex. 8 | 0.4 | 1200 × 1200 | Poor | Excellent | Excellent |
| Com. Ex. 3 | Production Ex. 9 | 0.4 | 1200 × 1200 | Poor | Poor | Excellent |
| Com. Ex. 4 | Production Ex. 10 | 0.4 | 1200 × 1200 | Excellent | Excellent | Poor |
| Com. Ex. 5 | Production Ex. 11 | 0.4 | 1200 × 1200 | Excellent | Poor | Poor |
| Com. Ex. 6 | Production Ex. 12 | 0.4 | 1200 × 1200 | Excellent | Good | Poor |
| Com. Ex. 7 | Production Ex. 13 | 0.5 | 1200 × 1200 | Poor | Excellent | Excellent |
| Com. Ex. 8 | Production Ex. 14 | 0.4 | 1200 × 1200 | Poor | Excellent | Excellent |
| Com. Ex. 0 | Production Ex. 15 | 0.4 | 1200 × 1200 | Poor | Excellent | Excellent |
| Com. Ex. 10 | Production Ex. 1 | 0.8 | 1200 × 1200 | Excellent | Poor | Poor |
| Com. Ex. 11 | Production Ex. 2 | 0.7 | 1200 × 1200 | Poor | Good | Poor |
| Com. Ex. 12 | Production Ex. 3 | 0.8 | 1200 × 1200 | Excellent | Poor | Poor |
| Com. Ex. 13 | Production Ex. 4 | 0.8 | 1200 × 1200 | Excellent | Poor | Poor |
| Com. Ex. 14 | Production Ex. 5 | 0.8 | 1200 × 1200 | Excellent | Poor | Poor |
| Com. Ex. 15 | Production Ex. 6 | 0.8 | 1200 × 1200 | Good | Poor | Poor |
| Com. Ex. 16 | Production Ex. 7 | 0.8 | 1200 × 1200 | Excellent | Poor | Poor |
| Com. Ex. 17 | Production Ex. 8 | 0.7 | 1200 × 1200 | Poor | Good | Poor |
| Com. Ex. 18 | Production Ex. 9 | 0.7 | 1200 × 1200 | Good | Poor | Poor |
| Com. Ex. 19 | Production Ex. 10 | 0.7 | 1200 × 1200 | Poor | Poor | Poor |
| Com. Ex. 20 | Production Ex. 11 | 0.7 | 1200 × 1200 | Excellent | Poor | Poor |
| Com. Ex. 21 | Production Ex. 12 | 0.7 | 1200 × 1200 | Excellent | Poor | Poor |
| Com. Ex. 22 | Production Ex. 13 | 0.7 | 1200 × 1200 | Poor | Good | Poor |
| Com. Ex. 23 | Production Ex. 14 | 0.7 | 1200 × 1200 | Poor | Good | Poor |
| Com. Ex. 24 | Production Ex. 15 | 0.7 | 1200 × 1200 | Poor | Poor | Poor |
| Com. Ex. 25 | Production Ex. 1 | 0.5 | 1200 × 600 | Excellent | Poor | Excellent |
| Com. Ex. 26 | Production Ex. 2 | 0.4 | 1200 × 600 | Excellent | Poor | Excellent |

From Table 1 and Table 2, it was confirmed that Examples 1 to 6 all exhibited favorable image density, beading, and drying properties.

On the other hand, in Comparative Examples 1 to 26, at least one of the image density, beading, or drying properties was poor.

The embodiments disclosed above include, for example, the following aspects.

### Aspect 1

An image forming apparatus, including
an ink composition including an organic solvent, water, a colorant, a resin, and a surfactant; and
a discharge head that discharges the ink composition onto a recording substrate, in which
the ink composition discharged by the discharge head has a deposition amount of 0.6 μL/cm² or less when printed on the recording substrate at a droplet count of 1200×1200 dpi,
a total solid content in the ink composition is 5% by mass or more and 15% by mass or less,
a content of the organic solvent in the ink composition is 14% by mass or more and 20% by mass or less,
the organic solvent includes a high-boiling point organic solvent having a boiling point of 200° C. or more and 300° C. or less,
a content of the organic solvent having the boiling point of 200° C. or more and 300° C. or less in the ink composition is 10% by mass or more and 20% by mass or less, and
the surfactant includes a compound represented by the following formula (1).

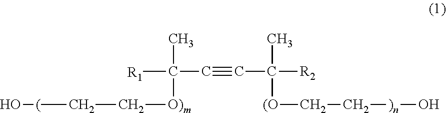

[In the formula (1), R₁ and R₂ each independently represent an alkyl group and n and m each independently represent an integer.]

### Aspect 2

The image forming apparatus according to Aspect 1, in which the boiling point of the high-boiling point organic solvent is 200° C. or more and 250° C. or less.

### Aspect 3

The image forming apparatus according to Aspect 1 or Aspect 2, in which the compound represented by the formula (1) is a compound represented by the following formula (2).

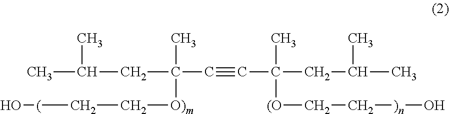

[In the formula (2), n and m each independently represent an integer.]

### Aspect 4

The image forming apparatus according to any one of Aspect 1 to Aspect 3, in which the compound represented by the formula (1) contains an ethylene oxide group in an amount of 50% by mass or more and 80% by mass or less.

### Aspect 5

The image forming apparatus according to any one of Aspect 1 to Aspect 4, in which a content of the surfactant in the ink composition is 0.3% by mass or more and 1.5% by mass or less.

### Aspect 6

The image forming apparatus according to Aspect 1, in which R₁ and R₂ in the formula (1) each independently have one to five carbon atoms.

### Aspect 7

The image forming apparatus according to any one of Aspect 1 to Aspect 6, in which a volume of ink droplets discharged by the discharge head is 1 pL or more and 5 pL or less.

### Aspect 8

The image forming apparatus according to any one of Aspect 1 to Aspect 7, in which the discharge head is an inkjet head.

### Aspect 9

An ink composition used for an image forming apparatus including a discharge head that discharges the ink composition onto a recording substrate, in which
the ink composition includes an organic solvent, a resin, and a surfactant,
the ink composition discharged by the discharge head has a deposition amount of 0.6 μL/cm² or less when printed on the recording substrate at a droplet count of 1200×1200 dpi,
a total solid content is 5% by mass or more and 15% by mass or less,
a content of the organic solvent is 14% by mass or more and 20% by mass or less,
the organic solvent includes a high-boiling point organic solvent having a boiling point of 200° C. or more and 300° C. or less,
a content of the high-boiling point organic solvent in the ink composition is 10% by mass or more and 20% by mass or less, and
the surfactant includes a compound represented by the following formula (1).

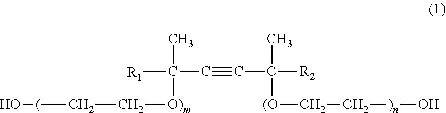

[In the formula (1), R₁ and R₂ each independently represent an alkyl group and n and m each independently represent an integer.]

Although the embodiments of the present disclosure have been described above, the present disclosure is not limited to the specific embodiments, and various modifications and changes are possible within the scope of the invention described in the claims.

The above-described embodiments are illustrative and do not limit the present invention. Thus, numerous additional modifications and variations are possible in light of the above teachings. For example, elements and/or features of different illustrative embodiments may be combined with each other and/or substituted for each other within the scope of the present invention.

1. An image forming apparatus comprising:
an ink composition having a total solid content of 5% by mass or more and 15% by mass or less, the ink composition including:
an organic solvent in an amount of 14% by mass or more and 20% by mass or less of the ink composition, the organic solvent including a high-boiling point organic solvent having a boiling point of 200° C. or more and 300° C. or less in an amount of 10% by mass or more and 20% by mass or less of the ink composition;
water;
a colorant;
a resin; and
a surfactant including a compound represented by the following formula (1): 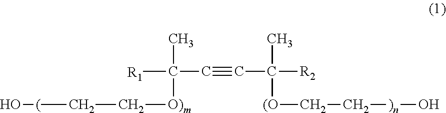
wherein, in the formula (1), R₁ and R₂ each independently represent an alkyl group and n and m each independently represent an integer; and
a discharge head to discharge the ink composition onto a recording substrate with a deposition amount of 0.6 μL/cm² or less when printing an image on the recording substrate at a droplet count of 1200×1200 dpi.

2. The image forming apparatus according to claim 1, wherein the high-boiling point organic solvent has a boiling point of 200° C. or more and 250° C. or less.

3. The image forming apparatus according to claim 1, wherein the compound represented by the formula (1) is a compound represented by the following formula (2): 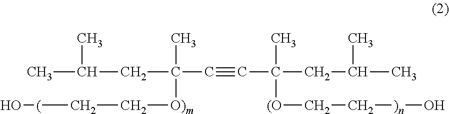
wherein, in the formula (2), n and m each independently represent an integer.

4. The image forming apparatus according to claim 1, wherein the compound represented by the formula (1) contains an ethylene oxide group in an amount of 50% by mass or more and 80% by mass or less.

5. The image forming apparatus according to claim 1, wherein the ink composition includes the surfactant in an amount of 0.3% by mass or more and 1.5% by mass or less.

6. The image forming apparatus according to claim 1, wherein R₁ and R₂ in the formula (1) each independently have one to five carbon atoms.

7. The image forming apparatus according to claim 1, wherein droplets of the ink composition discharged by the discharge head have a volume of 1 pL or more and 5 pL or less.

8. The image forming apparatus according to claim 1, wherein the discharge head is an inkjet head.

9. An ink composition comprising:
an organic solvent in an amount of 14% by mass or more and 20% by mass or less of the ink composition, the organic solvent including a high-boiling point organic solvent having a boiling point of 200° C. or more and 300° C. or less in an amount of 10% by mass or more and 20% by mass or less of the ink composition;
a resin; and
a surfactant including a compound represented by the following formula (1): 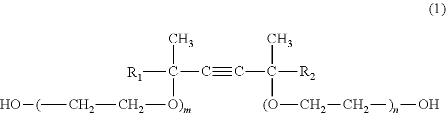
wherein, in the formula (1), R₁ and R₂ each independently represent an alkyl group and n and m each independently represent an integer,
wherein the ink composition has a total solid content of 5% by mass or more and 15% by mass or less.
